(19) United States
(12) Patent Application Publication
(10) Pub. No.: US 2026/0155907 A1
(43) Pub. Date: Jun. 4, 2026

(54) ADAPTIVE NETWORK TRANSMISSION FOR HIGH WIRELESS CONNECTION RELIABILITY

(71) Applicant: GM Global Technology Operations LLC, Detroit, MI (US)

(72) Inventors: Chuan Li, Troy, MI (US); Fan Bai, Ann Arbor, MI (US); Sheng Liu, Novi, MI (US)

(21) Appl. No.: 18/966,889

(22) Filed: Dec. 3, 2024

(51) Int. Cl. H04L 1/00; H04W 24/02; H04W 28/06; H04W 28/08

(52) U.S. Cl. CPC H04L 1/0002; H04W 24/02; H04W 28/06; H04W 28/0983

(57) ABSTRACT

A method for increasing network reliability for a wireless client may include determining a predicted bandwidth of the wireless client at a next time step. The method further may include determining a network status. The network status includes one of: a normal network status and a disruption event status. The method further may include determining an error correction block size based at least in part on the network status and the predicted bandwidth of the wireless client. The method further may include adjusting one or more server transmission characteristics of a server packet stream based at least in part on the error correction block size. The server packet stream includes a plurality of data packets. The method further may include transmitting the server packet stream to the wireless client based at least in part on the one or more server transmission characteristics.

### INTRODUCTION

The present disclosure relates to systems and methods for network communication reliability.

To provide network connectivity for wireless devices such as smartphones and vehicles, cellular communication technologies may be used. Cellular communications can provide bandwidth for tasks such as sensor fusion, vehicle-to-everything (V2X) communication, remote diagnostics, telecommunications, and/or the like. To ensure reliable communication in wireless applications, reliability protocols may be utilized. Reliability protocols may include error correction techniques configured to maintain data integrity during transmission tasks. For example, error detection, packet retransmission, redundancy checking, and/or the like may be used. Multiple protocols may be used in tandem to support high-speed and low-latency communication for critical applications, such as, for example, real-time control of vehicle systems or in-vehicle telecommunications (e.g., video conferencing). Cellular communication with reliability protocols allows wireless clients to exchange data in challenging conditions such as network congestion or environmental interference.

While systems and methods for network communication reliability achieve their intended purpose, there is a need for new and improved systems and methods for a system for increasing network reliability for wireless clients such as vehicles.

### SUMMARY

According to several aspects, a method for increasing network reliability for a wireless client is provided. The method may include determining a predicted bandwidth of the wireless client at a next time step. The method further may include determining a network status. The network status includes one of: a normal network status and a disruption event status. The method further may include determining an error correction block size based at least in part on the network status and the predicted bandwidth of the wireless client. The method further may include adjusting one or more server transmission characteristics of a server packet stream based at least in part on the error correction block size. The server packet stream includes a plurality of data packets. The method further may include transmitting the server packet stream to the wireless client based at least in part on the one or more server transmission characteristics.

In another aspect of the present disclosure, determining the error correction block size further may include determining a bandwidth budget based at least in part on the predicted bandwidth of the wireless client with a formula:

$${B}_{b} = {B}_{p} - {B}_{a}$$

where B_{b} is the bandwidth budget, Bₚ is the predicted bandwidth of the wireless client at the next time step, and Bₐ is a utilized bitrate of the wireless client at a current time step. Determining the error correction block size further may include determining a packet corruption probability. Determining the error correction block size further may include determining the error correction block size based at least in part on the bandwidth budget and the packet corruption probability using a formula:

$${N}_{e} = max ( min ( {N}_{w} , ⌈ \frac{1}{{P}_{c}} ⌉ ) , ⌊ \frac{{B}_{a}}{{B}_{b}} ⌋ )$$

where Nₑ is the error correction block size, N_{w} is a predetermined maximum number of packets to wait before decoding into video frames, P_{c} is the packet corruption probability, Bₐ is the utilized bitrate of the wireless client at the current time step, and Bₚ is the predicted bandwidth of the wireless client at the next time step.

In another aspect of the present disclosure, determining the packet corruption probability further may include determining the packet corruption probability using an inhomogeneous Poisson Point Process equation evaluated with a moving time window.

In another aspect of the present disclosure, determining the packet corruption probability further may include resetting the moving time window to begin at a current time in response to determining that the network status is the disruption event status.

In another aspect of the present disclosure, adjusting the one or more server transmission characteristics further may include generating one or more error correction packets for inclusion in the server packet stream based at least in part on the error correction block size. Adjusting the one or more server transmission characteristics further may include determining an optimized server bitrate for the next time step based at least in part on the error correction block size. Adjusting the one or more server transmission characteristics further may include determining an optimized keyframe transmission timing based at least in part on the error correction block size.

In another aspect of the present disclosure, generating the one or more error correction packets further may include grouping one or more of the plurality of data packets into a plurality of error correction blocks. A quantity of data packets in each of the plurality of error correction blocks is the error correction block size. Generating the one or more error correction packets further may include generating the one or more error correction packets. Each of the one or more error correction packets encodes one of the plurality of error correction blocks.

In another aspect of the present disclosure, grouping the one or more of the plurality of data packets into the plurality of error correction blocks further may include determining a packet importance of each of the plurality of data packets in response to determining that the network status is the disruption event status. Grouping the one or more of the plurality of data packets into the plurality of error correction blocks further may include grouping the one or more of the plurality of data packets into the plurality of error correction blocks based at least in part on the packet importance of each of the plurality of data packets in response to determining that the network status is the disruption event status.

In another aspect of the present disclosure, grouping the one or more of the plurality of data packets into the plurality of error correction blocks further may include comparing the packet importance of each of the plurality of data packets to a predetermined importance threshold. Grouping the one or more of the plurality of data packets into the plurality of error correction blocks further may include grouping the one or more of the plurality of data packets into the plurality of error correction blocks based at least in part on the packet importance of each of the plurality of data packets. Each of the plurality of error correction blocks includes one or more of the plurality of data packets having a packet importance greater than or equal to the predetermined importance threshold.

In another aspect of the present disclosure, determining the optimized server bitrate further may include determining the optimized server bitrate for the next time step using an optimization algorithm. A sum of the optimized server bitrate and an error correction bitrate does not exceed the predicted bandwidth of the wireless client. The error correction bitrate is determined based at least in part on the error correction block size. A decrease between the optimized server bitrate for a current time step and the optimized server bitrate for the next time step is minimized.

In another aspect of the present disclosure, determining the optimized keyframe transmission timing further may include determining a total keyframe data size to transmit a keyframe and associated keyframe error correction packets based at least in part on the error correction block size. Determining the optimized keyframe transmission timing further may include determining an estimated keyframe transmission duration based at least in part on the total keyframe data size and the predicted bandwidth for the next time step. Determining the optimized keyframe transmission timing further may include adjusting a keyframe transmission start time in response to determining that the estimated keyframe transmission duration is greater than a predetermined maximum waiting time.

According to several aspects, a system for increasing network reliability for a vehicle is provided. The system may include a server communication system in wireless communication with one or more wireless clients. The one or more wireless clients includes the vehicle. The system further may include a server controller in electrical communication with the server communication system. The server controller is programmed to determine a predicted bandwidth of the vehicle at a next time step. The server controller is further programmed to determine a network status of the vehicle. The network status includes one of: a normal network status and a disruption event status. The server controller is further programmed to determine an error correction block size based at least in part on the network status and the predicted bandwidth of the vehicle. The server controller is further programmed to generate one or more error correction packets for a server packet stream based at least in part on the error correction block size. The server packet stream includes a plurality of data packets. The server controller is further programmed to transmit the server packet stream and the one or more error correction packets to the vehicle using the server communication system.

In another aspect of the present disclosure, to determine the network status of the vehicle, the server controller is further programmed to determine the network status to be the disruption event status in response to determining that the vehicle has switched wireless base stations at a current time step or that the vehicle is predicted to switch wireless base stations at the next time step.

In another aspect of the present disclosure, to determine the error correction block size, the server controller is further programmed to determine a bandwidth budget based at least in part on the predicted bandwidth of the vehicle with a formula:

$${B}_{b} = {B}_{p} - {B}_{a}$$

where B_{b} is the bandwidth budget, Bₚ is the predicted bandwidth of the vehicle at the next time step, and Bₐ is a utilized bitrate of the vehicle at the current time step. To determine the error correction block size, the server controller is further programmed to determine a packet corruption probability using an inhomogeneous Poisson Point Process equation evaluated with a moving time window. To determine the error correction block size, the server controller is further programmed to determine the error correction block size based at least in part on the bandwidth budget and the packet corruption probability using a formula:

$${N}_{e} = max ( min ( {N}_{w} , ⌈ \frac{1}{{P}_{c}} ⌉ ) , ⌊ \frac{{B}_{a}}{{B}_{b}} ⌋ )$$

where Nₑ is the error correction block size, N_{w} is a predetermined maximum number of packets to wait before decoding into video frames, P_{c} is the packet corruption probability, Bₐ is the utilized bitrate of the vehicle at the current time step, and Bₚ is the predicted bandwidth of the vehicle at the next time step.

In another aspect of the present disclosure, to determine the packet corruption probability, the server controller is further programmed to reset the moving time window to begin at a current time in response to determining that the network status is the disruption event status.

In another aspect of the present disclosure, to generate the one or more error correction packets, the server controller is further programmed to group one or more of the plurality of data packets into a plurality of error correction blocks. A quantity of data packets in each of the plurality of error correction blocks is the error correction block size. To generate the one or more error correction packets, the server controller is further programmed to generate the one or more error correction packets. Each of the one or more error correction packets encodes one of the plurality of error correction blocks.

In another aspect of the present disclosure, to group the one or more of the plurality of data packets into the plurality of error correction blocks, the server controller is further programmed to determine a packet importance of each of the plurality of data packets in response to determining that the network status is the disruption event status. To group the one or more of the plurality of data packets into the plurality of error correction blocks, the server controller is further programmed to group the one or more of the plurality of data packets into the plurality of error correction blocks based at least in part on the packet importance of each of the plurality of data packets in response to determining that the network status is the disruption event status.

In another aspect of the present disclosure, to group the one or more of the plurality of data packets into the plurality of error correction blocks, the server controller is further programmed to compare the packet importance of each of the plurality of data packets to a predetermined importance threshold. To group the one or more of the plurality of data packets into the plurality of error correction blocks, the server controller is further programmed to group the one or more of the plurality of data packets into the plurality of error correction blocks based at least in part on the packet importance of each of the plurality of data packets. Each of the plurality of error correction blocks includes one or more of the plurality of data packets having a packet importance greater than or equal to the predetermined importance threshold.

According to several aspects, a method for increasing network reliability for a vehicle is provided. The method may include determining a predicted bandwidth of the vehicle at a next time step. The method further may include determining a network status. The network status includes one of: a normal network status and a disruption event status. The disruption event status indicates that the vehicle has switched wireless base stations at a current time step or that the vehicle is predicted to switch wireless base stations at the next time step. The method further may include determining an error correction block size based at least in part on the network status and the predicted bandwidth of the vehicle. The method further may include generating one or more error correction packets for inclusion in a server packet stream based at least in part on the error correction block size. The server packet stream includes a plurality of data packets. The method further may include transmitting the server packet stream including the one or more error correction packets to the vehicle.

In another aspect of the present disclosure, determining the error correction block size further may include determining a bandwidth budget based at least in part on the predicted bandwidth of the vehicle with a formula:

$${B}_{b} = {B}_{p} - {B}_{a}$$

where B_{b} is the bandwidth budget, Bₚ is the predicted bandwidth of the vehicle at the next time step, and Bₐ is a utilized bitrate of the vehicle at the current time step. Determining the error correction block size further may include determining a packet corruption probability using an inhomogeneous Poisson Point Process equation evaluated with a moving time window. Determining the error correction block size further may include resetting the moving time window to begin at a current time in response to determining that the network status is the disruption event status. Determining the error correction block size further may include determining the error correction block size based at least in part on the bandwidth budget and the packet corruption probability using a formula:

$${N}_{e} = max ( min ( {N}_{w} , ⌈ \frac{1}{{P}_{c}} ⌉ ) , ⌊ \frac{{B}_{a}}{{B}_{b}} ⌋ )$$

where Nₑ is the error correction block size, N_{w} is a predetermined maximum number of packets to wait before decoding into video frames, P_{c} is the packet corruption probability, Bₐ is the utilized bitrate of the vehicle at the current time step, and Bₚ is the predicted bandwidth of the vehicle at the next time step.

In another aspect of the present disclosure, generating the one or more error correction packets further may include determining a packet importance of each of the plurality of data packets in response to determining that the network status is the disruption event status. Generating the one or more error correction packets further may include comparing the packet importance of each of the plurality of data packets to a predetermined importance threshold. Generating the one or more error correction packets further may include grouping the one or more of the plurality of data packets into a plurality of error correction blocks based at least in part on the packet importance of each of the plurality of data packets. A quantity of data packets in each of the plurality of error correction blocks is the error correction block size. Each of the plurality of error correction blocks includes one or more of the plurality of data packets having a packet importance greater than or equal to the predetermined importance threshold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for increasing network reliability for a wireless device such as a vehicle, according to an exemplary embodiment;

FIG. 2A is a flowchart of a method for increasing network reliability for a wireless device such as a vehicle, according to an exemplary embodiment; and

FIG. 2B is a continuation of the flowchart of FIG. 2A, according to an exemplary embodiment.

### DETAILED DESCRIPTION

The following description is merely exemplary in nature and is not intended to limit the present disclosure, application, or uses.

In aspects of the present disclosure, wireless clients including, for example, vehicles, may move through the environment at high speed, resulting in decreased wireless (e.g., cellular) connection reliability and consistency. This may result in a degraded user experience for some applications, particularly those reliant on real-time data streaming, such as, for example, video streaming and video conferencing. Accordingly, the present disclosure provides a new and improved system and method for increasing network reliability for wireless clients like vehicles.

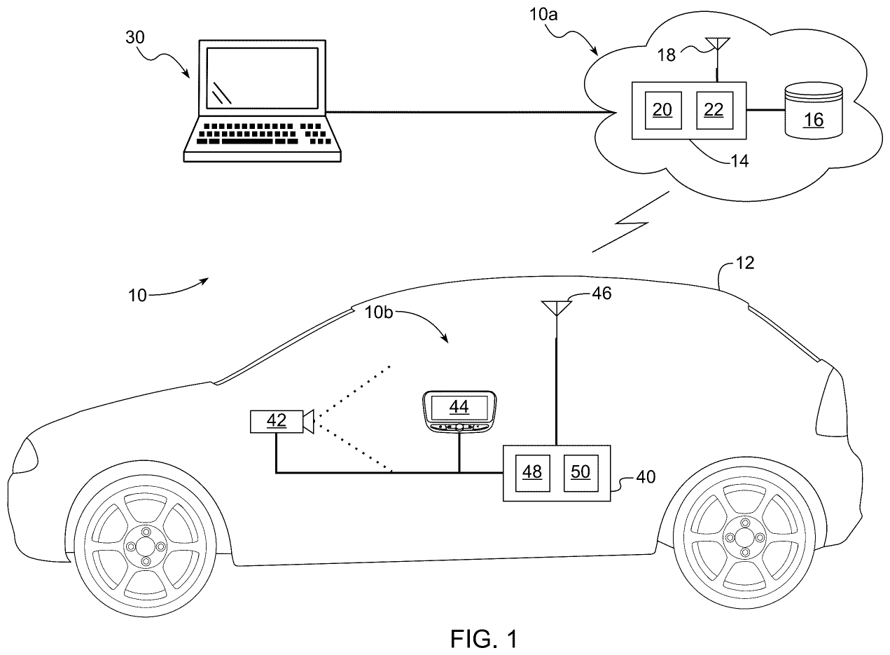

Referring to FIG. 1, a system for increasing network reliability for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a server system 10a and a vehicle system 10b.

The server system 10a includes a server controller 14 in electrical communication with a server database 16 and a server communication system 18. In a non-limiting example, the server system 10a is located in a server farm, datacenter, or the like, and connected to the internet.

The server controller 14 is used to implement a method 100 for increasing network reliability for a vehicle, as will be described below. The server controller 14 includes at least one server processor 20 and a non-transitory computer readable server storage device or server media 22. The server processor 20 may be a custom made or commercially available processor, a central processing unit (CPU), a graphics processing unit (GPU), an auxiliary processor among several processors associated with the server controller 14, a semiconductor-based microprocessor (in the form of a microchip or chip set), a macroprocessor, a combination thereof, or generally a device for executing instructions.

The computer readable server storage device or server media 22 may include volatile and nonvolatile storage in read-only memory (ROM), random-access memory (RAM), and keep-alive memory (KAM), for example. KAM is a persistent or non-volatile memory that may be used to store various operating variables while the server processor 20 is powered down. The computer-readable storage device or server media 22 may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions. The server controller 14 may also include multiple controllers which are in electrical communication with each other.

The server controller 14 is in electrical communication with the server database 16 and the server communication system 18. In an exemplary embodiment, the electrical communication is established using, for example, a CAN network, a FLEXRAY network, a local area network (e.g., WiFi, ethernet, and the like), a serial peripheral interface (SPI) network, peripheral component interconnect (PCI), and/or the like. It should be understood that various additional wired and wireless techniques and communication protocols for communicating with the server controller 14 are within the scope of the present disclosure. It should further be understood that, in the scope of the present disclosure, electrical communication also includes power and/or energy transfer between electrical devices (e.g., using conducting wires and/or wireless power transmission techniques).

The server database 16 is used to store and/or buffer data for transmission to external devices. In an exemplary embodiment, the server database 16 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 14 may execute software such as, for example, a database management system (DBMS), allowing data stored on the one or more mass storage devices to be organized and accessed.

The server communication system 18 is used by the server controller 14 to communicate with other systems external to the server system 10a (e.g., wireless clients such as the vehicle system 10b).

In certain embodiments, the server communication system 18 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the server communication system 18 may further include an embedded universal integrated circuit card (eUICC) configured to store at least one cellular connectivity configuration profile, for example, an embedded subscriber identity module (eSIM) profile.

The server communication system 18 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

It should be understood that the server communication system 18 may be integrated with the server controller 14 (e.g., on a same circuit board with the server controller 14 or otherwise a part of the server controller 14) without departing from the scope of the present disclosure. Furthermore, while not shown in FIG. 1, it should be understood that wireless communication between the server communication system 18 and the one or more wireless clients may be facilitated by additional infrastructure, such as, for example, a cellular network including cellular base stations.

In an exemplary embodiment, the server system 10a is in wireless communication with one or more wireless clients. In a non-limiting example, the one or more wireless clients includes a computing device such as a laptop 30. In a non-limiting example, the one or more wireless clients further includes the vehicle system 10b. In an exemplary embodiment, the server system 10a uses the server communication system 18 to transmit data to the one or more wireless clients using forward error correction (FEC). In a non-limiting example, the data includes one or more video streams for a video conferencing application. FEC allows errors in data packets to be corrected without the need for retransmission of data. The data which the server system 10a is transmitting to the one or more wireless clients is encapsulated in a plurality of data packets. In a non-limiting example, each video frame of the one or more video streams is encapsulated in one or more data packets.

One or more groups of the plurality of data packets, referred to as error correction blocks, are encoded to generate one or more error correction packets. Each error correction packet encodes information derived from the data packets within the corresponding error correction block using a predefined algorithm such as, for example, Reed-Solomon or LDPC (Low-Density Parity Check).

The quantity of data packets in each error correction block, referred to as the error correction block size, controls both a robustness of the error correction and an amount of additional bandwidth consumed by error correction. As the error correction block size is decreased, the robustness of the error correction (i.e., an amount of data packets which may be lost/corrupted without actual data loss) increases, and the amount of additional bandwidth consumed by error correction increases. As the error correction block size is increased, the robustness of the error correction decreases, and the amount of additional bandwidth consumed by error correction decreases.

The generated error correction packets are transmitted to the one or more wireless clients alongside the plurality of data packets as a stream of packets referred to as a server packet stream. The one or more wireless clients then receive the network transmission including the plurality of data packets and the generated error correction packets. If one or more of the plurality of data packets are lost or corrupted during transmission, the one or more wireless clients use the information in the error correction packets to reconstruct the missing or erroneous data packets. It should be understood that the preceding description of forward error correction (FEC) is merely exemplary in nature, that the process of FEC may include various additional steps, and that FEC may be realized using various additional systems, methods, protocols, and/or techniques without departing from the scope of the present disclosure.

Furthermore, in a non-limiting example, the server system 10a provides multiple simultaneous data streams to wireless clients having different bitrates (e.g., using simulcast or scalable video coding protocols). For example, the server system 10a may provide a high-bitrate stream within a high-bitrate range (e.g., 2 to 3 megabits per second), a medium-bitrate stream within a medium-bitrate range (e.g., 1 to 1.5 megabits per second), and a low-bitrate stream within a low-bitrate range (e.g., 300 to 600 kilobits per second). Each wireless client may choose to receive one of the simultaneous data streams.

With continued reference to FIG. 1, the vehicle system 10b includes a vehicle controller 40 in electrical communication with an interior camera 42, a display 44, and a vehicle communication system 46.

The vehicle controller 40 includes at least one processor 48 and a non-transitory computer readable storage device or media 50. The processor 48 may be a custom made or commercially available processor, a central processing unit (CPU), a graphics processing unit (GPU), an auxiliary processor among several processors associated with the vehicle controller 40, a semiconductor-based microprocessor (in the form of a microchip or chip set), a macroprocessor, a combination thereof, or generally a device for executing instructions.

The computer readable storage device or media 50 may include volatile and nonvolatile storage in read-only memory (ROM), random-access memory (RAM), and keep-alive memory (KAM), for example. KAM is a persistent or non-volatile memory that may be used to store various operating variables while the processor 48 is powered down. The computer-readable storage device or media 50 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 40 to control various systems of the vehicle 12.

The vehicle controller 40 may also include multiple controllers which are in electrical communication with each other. The vehicle controller 40 may be inter-connected with additional systems and/or controllers of the vehicle 12, allowing the vehicle controller 40 to access data such as, for example, speed, acceleration, braking, and steering angle of the vehicle 12.

The vehicle controller 40 is in electrical communication with the interior camera 42, the display 44, and the vehicle communication system 46. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 40 are within the scope of the present disclosure. It should further be understood that, in the scope of the present disclosure, electrical communication also includes power and/or energy transfer between electrical devices (e.g., using conducting wires and/or wireless power transmission techniques).

The interior camera 42 is used to capture images and/or videos of the environment within the vehicle 12. In an exemplary embodiment, the interior camera 42 is a photo and/or video camera which is positioned to view the environment within a cabin of the vehicle 12. In one example, the interior camera 42 is affixed inside of the vehicle 12, for example, in a headliner of the vehicle 12, having a view towards one or more seats of the vehicle 12. It should be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The display 44 is used to provide information to an occupant of the vehicle 12. In the scope of the present disclosure, the occupant includes a driver and/or a passenger of the vehicle 12. In an exemplary embodiment, the display 44 is a human-machine interface (HMI) located in view of the occupant and capable of displaying text, graphics and/or images. It is to be understood that HMI display systems including LCD displays, LED displays, and the like are within the scope of the present disclosure. Further exemplary embodiments where the display 44 is disposed in a rearview mirror are also within the scope of the present disclosure. In another exemplary embodiment, the display 44 includes a head-up display (HUD) configured to provide information to the occupant by projecting text, graphics, and/or images upon the windscreen of the vehicle 12. The text, graphics, and/or images are reflected by the windscreen of the vehicle 12 and are visible to the occupant without looking away from a roadway ahead of the vehicle 12. In another exemplary embodiment, the display 44 includes an augmented reality head-up display (AR-HUD). The AR-HUD is a type of HUD configured to augment the occupant's vision of the roadway ahead of the vehicle 12 by overlaying text, graphics, and/or images on physical objects in the environment surrounding the vehicle 12 within a field-of-view of the occupant. In an exemplary embodiment, the occupant may interact with the display 44 using a human-interface device (HID), including, for example, a touchscreen, an electromechanical switch, a capacitive switch, a rotary knob, and the like. It should be understood that additional systems for displaying information to the occupant of the vehicle 12 are also within the scope of the present disclosure.

The vehicle communication system 46 is used by the vehicle controller 40 to communicate with other systems external to the vehicle 12. For example, the vehicle communication system 46 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 46 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 46 may further include an embedded universal integrated circuit card (eUICC) configured to store at least one cellular connectivity configuration profile, for example, an embedded subscriber identity module (eSIM) profile.

The vehicle communication system 46 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 46 may include one or more antennas and/or communication transceivers for receiving and/or transmitting signals, such as cooperative sensing messages (CSMs). The vehicle communication system 46 is configured to wirelessly communicate information between the vehicle 12 and another vehicle. Further, the vehicle communication system 46 is configured to wirelessly communicate information between the vehicle 12 and infrastructure or other vehicles. It should be understood that the vehicle communication system 46 may be integrated with the vehicle controller 40 (e.g., on a same circuit board with the vehicle controller 40 or otherwise a part of the vehicle controller 40) without departing from the scope of the present disclosure.

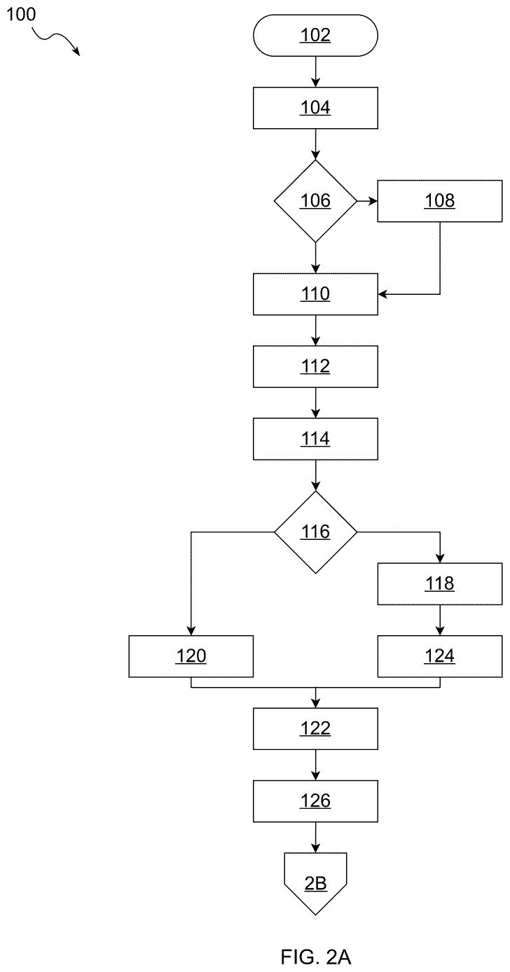

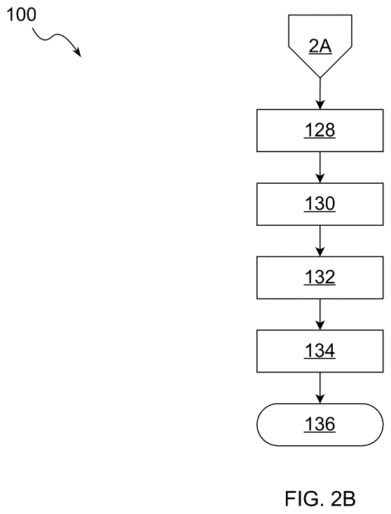

Referring to FIG. 2A, a flowchart of the method 100 for increasing network reliability for a vehicle is shown. The method 100 begins at block 102 and proceeds to block 104. At block 104, a predicted bandwidth of the wireless client is determined. In the scope of the present disclosure, the wireless client may include the vehicle 12 and/or a mobile device (e.g., a smartphone, laptop, etc.) in wireless (e.g., cellular) communication with the server system 10a via wireless infrastructure (e.g., cellular base stations). In the scope of the present disclosure, the predicted bandwidth is a predicted future bandwidth of the wireless client based on, for example, the wireless signal environment, wireless signal strength, network congestion, and/or the like. In a non-limiting example, the predicted bandwidth is determined at one or more future time steps (e.g., a next time step). In an exemplary embodiment, the predicted bandwidth is determined using systems and methods discussed in, for example, U.S. application Ser. No. 18/494,189, titled “PREDICTING 5G USER PLANE USING CONTROL PLANE FEATURES AND GRANGER CAUSALITY FOR FEATURE SELECTION”, filed on Oct. 25, 2023, the entire contents of which is hereby incorporated by reference. After block 104, the method 100 proceeds to block 106.

At block 106, the server controller 14 determines a network status of the wireless client. In the scope of the present disclosure, the network status includes one of: a normal network status and a disruption event status. In the scope of the present disclosure, the normal network status indicates normal operation of the wireless connection between the server system 10a and the vehicle system 10b, for example, having a nominal signal strength, nominal bandwidth, nominal latency, and/or the like. In the scope of the present disclosure, the disruption event status indicates disruption to control plane operations of the wireless connection between the server system 10a and the vehicle system 10b, causing, for example, a reduced bandwidth, a reduced signal strength, an increased latency, and/or the like.

The disruption event status is caused by a disruption event. In a non-limiting example, the disruption event includes the wireless client switching base stations. In an exemplary embodiment, the network status is determined to be the disruption event status in response to determining that the wireless client (e.g., the vehicle 12) has switched wireless base stations at a previous time step, at a current time step, or that the wireless client is predicted to switch wireless base stations at the next time step. In a non-limiting example, base station switches may be predicted based on a location and heading of the wireless client in relation to nearby base stations.

If the network status of the wireless client is determined to be the disruption event status, the method 100 proceeds to block 108, as will be discussed in greater detail below. If the network status of the wireless client is determined to be the normal network status, the method 100 proceeds to block 110.

At block 110, the server controller 14 determines a packet corruption probability. In the scope of the present disclosure, the packet corruption probability is a probability that a network packet being transmitted from the server system 10a to the wireless client (e.g., the vehicle system 10b) will be corrupted. In the scope of the present disclosure, corruption refers to degradation of the network packet because of inherent limitations of the wireless networking protocol (e.g., due to wireless interference, encoding/decoding errors, and/or additional probabilistic processes). Degradation or loss of data packets caused by network congestion (i.e., more network traffic than available network bandwidth) is not considered to be “corruption” in the scope of the present disclosure. In an exemplary embodiment, the packet corruption probability is determined using an inhomogeneous Poisson Point Process equation evaluated with a moving time window:

$${P}_{c} = Pr \{ N ( {t}_{0} , {t}_{now} ) = n + 1 \} = \frac{{( Λ ( {t}_{0} , {t}_{now} ) )}^{n + 1}}{( n + ! ) !} {e}^{- Λ ( {t}_{0} , {t}_{now} )} \qquad ( 1 )$$

$$Λ ( {t}_{0} , {t}_{now} ) = {\int }_{{t}_{0}}^{{t}_{now}} λ ( t ) dt \qquad ( 2 )$$

where P_{c} is the probability that a network packet being transmitted from the server system 10a to the wireless client (e.g., the vehicle system 10b) will be corrupted, t₀ is the start time instant of the moving time window, t_{now} is the current time, n is the number of corrupted network packets observed in the interval [t₀, t_{now}), Pr {N (t₀, t_{now})=n+1} is the probability that exactly n+1 corrupted network packets will occur in the interval [t₀, t_{now}], meaning one more corrupted network packet will be observed at t_{now}, λ(t) is an intensity function representing the instantaneous probability that a network packet will be corrupted at time t (e.g., determined based on observations of network packet corruption in the interval [t₀, t_{now}]), and Λ(t₀, t_{now}) is a cumulative intensity function representing the expected total number of corrupted network packets that will occur in the interval [t₀, t_{now}].

In a non-limiting example, the moving time window has a predetermined length (e.g., five seconds) which may be adjusted based on, for example, network conditions. In some circumstances, the moving time window may be “reset” to begin at the current time, as will be discussed in greater detail below. It should be understood that additional methods, including, for example, machine learning methods, for determining the packet corruption probability are also within the scope of the present disclosure. After block 110, the method 100 proceeds to block 112, as will be discussed in greater detail below.

At block 108, the server controller 14 resets the moving time window in response to determining that the network status is the disruption event status at block 106. The disruption event may cause changes in wireless connection performance; thus, it is advantageous to reset the moving time window such that connection performance after the disruption event is accounted for. In an exemplary embodiment, to is moved forward in time to the disruption event (e.g., to is moved to the time of a cellular base station switch event). After block 108, the method 100 proceeds to block 110 as discussed above, but with the moving time window including time after the disruption event (i.e., such that t₀≥t_{d}, where t_{d} is the time of the disruption event).

At block 112, the server controller 14 determines a bandwidth budget of the wireless client. In the scope of the present disclosure, the bandwidth budget is a predicted unutilized bandwidth of the wireless client at the next time step. In an exemplary embodiment, the bandwidth budget is calculated using a formula:

$${B}_{b} = {B}_{p} - {B}_{a} \qquad ( 3 )$$

where B_{b} is the bandwidth budget, Bₚ is the predicted bandwidth of the wireless client at the next time step as determined at block 104, and Bₐ is a utilized bitrate of the wireless client at the current time step. In a non-limiting example, the utilized bitrate of the wireless client at the current time step is known based on the bitrate of data currently being transmitted from the server system 10a to the wireless client. After block 112, the method 100 proceeds to block 114.

At block 114, the server controller 14 determines an error correction block size. In the scope of the present disclosure, the error correction block size is a quantity of data packets which are encoded in each forward error correction (FEC) packet, as discussed above. In an exemplary embodiment, the error correction block size is determined based at least in part on the bandwidth budget determined at block 112 and the packet corruption probability determined at block 110. In a non-limiting example, the error correction block size is determined using a formula:

$${N}_{e} = max ( min ( {N}_{w} , ⌈ \frac{1}{{P}_{c}} ⌉ ) , ⌊ \frac{{B}_{a}}{{B}_{b}} ⌋ ) \qquad ( 4 )$$

where Nₑ is the error correction block size, N_{w} is a predetermined maximum number of data packets to wait before further data processing, for example, decoding into video frames (e.g., based on a predetermined data lag tolerance of the wireless client), P_{c} is the packet corruption probability determined at block 110, Bₐ is the utilized bitrate of the wireless client at the current time step determined at block 112, and Bₚ is the predicted bandwidth of the wireless client at the next time step determined at block 104. After block 114, the method 100 proceeds to block 116.

At block 116, the server controller 14 determines the network status of the wireless client as discussed above in reference to block 106. If the network status of the wireless client is determined to be the disruption event status, the method 100 proceeds to block 118, as will be discussed in greater detail below. If the network status of the wireless client is determined to be the normal network status, the method 100 proceeds to block 120.

At block 120, the server controller 14 groups one or more of the plurality of data packets into a plurality of error correction blocks. The quantity of data packets in each error correction block is the error correction block size as discussed above and determined at block 114. In an exemplary embodiment, each of plurality of data packets is included in the plurality of error correction blocks. In another exemplary embodiment, a predetermined fraction of the plurality of data packets are included in the plurality of error correction blocks, and data packets which are not included are not protected by error correction. After block 120, the method 100 proceeds to block 122, as will be discussed in greater detail below.

At block 118, the server controller 14 determines a packet importance of each of the plurality of data packets in response to determining that the network status is the disruption event status. In the scope of the present disclosure, the packet importance describes an importance of a particular data packet in the context of the server packet stream. For example, in the context of video steaming, data packets encoding keyframes may be considered to have a high packet importance because the keyframes are critical for proper playback of the video stream. In an exemplary embodiment, the packet importance is described by a formula:

$${I}_{p} = α {e}^{- βα} \qquad ( 5 )$$

where Iₚ is the packet importance, a is a predetermined constant, e is a mathematical constant (sometimes called Napier's constant), and β is a variable which is adjusted based on the content of the data packet.

In a non-limiting example, for data packets encoding keyframes, the packet importance is defined by Equation 5 with β=1. In another non-limiting example, for data packets encoding temporal layer one delta frames, the packet importance is defined by Equation 5 with β=2. In another non-limiting example, for data packets encoding temporal layer two delta frames, the packet importance is defined by Equation 5 with β=3. It should be understood that the packet importance may be determined based on other factors for different types of data besides video streams, including, for example, importance information encoded in the data packets themselves. After block 118, the method 100 proceeds to block 124.

At block 124, the server controller 14 groups one or more of the plurality of data packets into the plurality of error correction blocks. The quantity of data packets in each error correction block is the error correction block size as discussed above and determined at block 114. In an exemplary embodiment, the one or more of the plurality of data packets are grouped into the plurality of error correction blocks based at least in part on the packet importance of each of the plurality of data packets determined at block 118.

In a non-limiting example, the packet importance of each of the plurality of data packets is compared to a predetermined importance threshold and each of the plurality of error correction blocks includes one or more of the plurality of data packets having a packet importance greater than or equal to the predetermined importance threshold. In another non-limiting example, each of the plurality of error correction blocks includes only data packets having a packet importance greater than or equal to the predetermined importance threshold. Data packets which are not included in the plurality of error correction blocks are not protected by error correction. After block 124, the method 100 proceeds to block 122.

At block 122, the server controller 14 generates one or more error correction packets for inclusion in the server packet stream. Each of the one or more error correction packets encodes one of the plurality of error correction blocks based on the results of block 120 or block 124. After block 122, the method 100 proceeds to block 126.

At block 126, the server controller 14 determines an optimized server bitrate for the next time step. In the scope of the present disclosure, the server bitrate is a bitrate with which the server system 10a transmits the server data stream to the wireless clients. In an exemplary embodiment, the server controller 14 optimizes the bitrate within the ranges discussed above (e.g., the high-bitrate range, the medium-bitrate range, and the low-bitrate range) based at least in part on the quantity of error correction packets generated at block 122.

In a non-limiting example, the optimized server bitrate for each stream is determined using an optimization algorithm with one or more constraints. A first constraint is that a sum of the optimized server bitrate and an error correction bitrate (based on the quantity of error correction packets generated at block 122, which is based on the error correction block size determined at block 114) does not exceed the predicted bandwidth of the wireless client determined at block 104. A second constraint is that the optimized server bitrate for each stream must be within the bitrate range for the stream. The server bitrate for each stream is optimized such as to minimize a decrease between the optimized server bitrate for the current time step and the optimized server bitrate for the next time step.

In a non-limiting example, the selected server data stream for each wireless client can be represented as a matrix:

$$I = [ \begin{matrix}l \\ m \\ h\end{matrix} ] \qquad ( 6 )$$

where:

$$l , m , h ∈ \{ 0 , 1 \} \qquad ( 7 )$$

$$l + m + h = 1 \qquad ( 8 )$$

where I is an indicator matrix indicating which server data stream is selected by the wireless client, l corresponds to the low-bitrate stream, m corresponds to the medium-bitrate stream, and h corresponds to the high-bitrate stream. The value l=1 means that the low-bitrate stream is selected, m=1 means that the medium-bitrate stream is selected, and h=1 means that the high-bitrate stream is selected.

The first constraint may be represented as:

$$( {b}_{l} ( {t}_{now + 1} ) + {b}_{m} ( {t}_{now + 1} ) + {b}_{h} ( {t}_{now + 1} ) ) {I}^{T} \leq {B}_{p} \qquad ( 9 )$$

where:

$${b}_{l} ( {t}_{now + 1} ) = {b}_{l , d} ( {t}_{now + 1} ) + {b}_{l , ec} ( {t}_{now} ) \qquad ( 10 )$$

$${b}_{m} ( {t}_{now + 1} ) = {b}_{m , d} ( {t}_{now + 1} ) + {b}_{m , ec} ( {t}_{now} ) \qquad ( 11 )$$

$${b}_{h} ( {t}_{now + 1} ) = {b}_{h , d} ( {t}_{now + 1} ) + {b}_{h , ec} ( {t}_{now} ) \qquad ( 12 )$$

where bₗ(t_{now+1}) is the optimized server bitrate at the next time step for the low-bitrate stream, bₘ(t_{now+1}) is the optimized server bitrate at the next time step for the medium-bitrate stream, bₕ(t_{now+1}) is the optimized server bitrate at the next time step for the high-bitrate stream, IT is a transposition of the indicator matrix for the wireless client, and Bₚ is the predicted bandwidth of the wireless client at the next time step. Furthermore, b_{l,d}(t_{now+1}) is the contribution of the plurality of data packets to the optimized server bitrate at the next time step for the low-bitrate stream, b_{m,d}(t_{now+1}) is the contribution of the plurality of data packets to the optimized server bitrate at the next time step for the medium-bitrate stream, and b_{h,d}(t_{now+1}) is the contribution of the plurality of data packets to the optimized server bitrate at the next time step for the high-bitrate stream. Furthermore, b_{l,ec}(t_{now}) is the contribution of the error correction packets to the optimized server bitrate at the current time step for the low-bitrate stream, b_{m,ec}(t_{now}) is the contribution of the error correction packets to the optimized server bitrate at the current time step for the medium-bitrate stream, and b_{h,ec}(t_{now}) is the contribution of the error correction packets to the optimized server bitrate at the current time step for the high-bitrate stream.

The second constraint may be represented as:

$${b}_{l} ( {t}_{now + 1} ) ∈ [ {b}_{l}^{min} , {b}_{l}^{max} ] \qquad ( 13 )$$

$${b}_{m} ( {t}_{now + 1} ) ∈ [ {b}_{m}^{min} , {b}_{m}^{max} ] \qquad ( 14 )$$

$${b}_{h} ( {t}_{now + 1} ) ∈ [ {b}_{h}^{min} , {b}_{h}^{max} ] \qquad ( 15 )$$

where

$${b}_{l}^{min}$$

is a lower bound of the low-bitrate range,

$${b}_{max}^{l}$$

is an upper bound of the low-bitrate range,

$${b}_{m}^{min}$$

is a lower bound of the medium-bitrate range,

$${b}_{m}^{max}$$

is an upper bound or the medium-bitrate range,

$${b}_{h}^{min}$$

is a lower bound of the high-bitrate range, and

$${b}_{h}^{max}$$

is an upper bound of the high-bitrate range.

The optimization goal may be represented as:

$${min}_{{b}_{l} ( {t}_{now + 1} ) , {b}_{m} ( {t}_{now + 1} ) , {b}_{h} ( {t}_{now + 1} )} [ \begin{matrix}( {b}_{l} ( {t}_{now} ) - {b}_{l} ( {t}_{now + 1} ) ) + \\ ( {b}_{m} ( {t}_{now} ) - {b}_{m} ( {t}_{now + 1} ) ) + \\ ( {b}_{h} ( {t}_{now} ) - {b}_{h} ( {t}_{now + 1} ) )\end{matrix} ] \qquad ( 16 )$$

subject to the first and second constraints (i.e., Equations 9-15) discussed above. In a non-limiting example, the optimization is performed using an optimization algorithm such as, for example, gradient descent, Newton's method, genetic algorithms, dynamic programming, linear programming, linear regression, least squares, and/or the like.

It should be understood that the preceding mathematical representation of the optimization problem is merely exemplary in nature, and that alternate representations are also within the scope of the present disclosure. It should also be understood that the server bitrate may be optimized for each data stream and for each wireless client, such that each individual wireless client receives optimized data streams based on the predicted bandwidth and error correction packet quantity of that individual wireless client. While the preceding mathematical representation is discussed in terms of one wireless client for the sake of explanation, one of ordinary skill in the art will appreciate that it is trivial to extend the mathematical representation to be applicable for simultaneous optimization for a plurality of wireless clients. After block 126, the method 100 proceeds to block 128 shown in FIG. 2B.

Referring to FIG. 2B, a continuation of the flowchart of the method 100 for increasing network reliability for a vehicle is shown. At block 128, a total keyframe data size is determined. The total keyframe data size is a total amount of data which must be transmitted to send one keyframe and associated keyframe error correction packets from the server system 10a to the wireless client. The total keyframe data size depends on characteristics of the keyframe (e.g., size, resolution, etc.) and the associated keyframe error correction packets (i.e., the quantity of error correction packets generated at block 122). After block 128, the method 100 proceeds to block 130.

At block 130, an estimated keyframe transmission duration is determined. The estimated keyframe transmission duration is an estimated time required to transmit the keyframe and associated error correction packets. In an exemplary embodiment, the estimated keyframe transmission duration is determined based on the total keyframe data size determined at block 128 and the predicted bandwidth for the next time step determined at block 104.

In a non-limiting example, the estimated keyframe transmission duration is given by solving:

$$( {{\int }_{{t}_{s}}}^{{t}_{s} + {t}_{kf}} {B}_{p} ( u ) d ( u ) ) = {s}_{kf} \qquad ( 17 )$$

for t_{kf}, where t_{kf} is the estimated keyframe transmission duration, tₛ is the keyframe transmission start time, Bₚ(u) is the predicted bandwidth for a time u, and s_{kf} is the total keyframe data size determined at block 128. After block 130, the method 100 proceeds to block 132.

At block 132, the server controller 14 adjusts a keyframe transmission start time to determine an optimized keyframe transmission timing in response to determining that the estimated keyframe transmission duration is greater than a predetermined maximum waiting time. In the scope of the present disclosure, the predetermined maximum waiting time is a maximum time that the wireless client can wait to receive a keyframe before video playback is disrupted.

In a non-limiting example, the keyframe transmission start time is adjusted such that:
if:

$${t}_{kf} > {t}_{w} \qquad ( 18 )$$

then adjust tₛ such that:

$$( {{\int }_{{t}_{s}}}^{{t}_{s} + {t}_{w}} {B}_{p} ( u ) d ( u ) ) = {s}_{kf} \qquad ( 19 )$$

where t_{kf} is the estimated keyframe transmission duration determined at block 130, t_{w} is the predetermined maximum waiting time, tₛ is the keyframe transmission start time, Bₚ(u) is the predicted bandwidth for a time u, and s_{kf} is the total keyframe data size determined at block 128. In a non-limiting example, the keyframe transmission start time is adjusted within a predetermined range (e.g., tₛ∈[tₛ−tₐ, tₛ+tₐ], where tₐ is a predetermined maximum adjustment amount) to satisfy Equation 19.

It should be understood that while blocks 128, 130, and 132 are discussed in the context of a video streaming application, the method 100 and blocks 128, 130, and 132 are also applicable to other types of data having important components analogous to keyframes. After block 132, the method 100 proceeds to block 134.

At block 134, the server controller 14 transmits the server packet stream and the one or more error correction packets to the wireless client(s) (e.g., the vehicle system 10b) using the server communication system 18 based at least in part on one or more server transmission characteristics. In the scope of the present disclosure, the one or more server transmission characteristics include the error correction parameters determined at blocks 114 and 120 or 124, the optimized server bitrate determined at block 126, and the optimized keyframe transmission timing determined at block 132. In an exemplary embodiment where the wireless client(s) includes the vehicle system 10b, the vehicle controller 40 receives the server packet stream using the vehicle communication system 46 and uses the one or more error correction packets to perform any necessary error correction.

In an exemplary embodiment where the system 10 and method 100 are used for a video conferencing application, the vehicle controller 40 uses the display 44 to display a received video stream to the occupant of the vehicle 12. The vehicle controller 40 uses the interior camera 42 to capture a video stream and transmit the captured video stream to the server system 10a. It should be understood that the method 100 is also applicable for use by the vehicle controller 40 when transmitting the captured video stream to the server system 10a. After block 134, the method 100 proceeds to enter a standby state at block 136.

In an exemplary embodiment, the method 100 is repeatedly restarted at block 102. In a non-limiting example, the method 100 exits the standby state 136 and is restarted on a timer, for example, every three hundred milliseconds.

The system 10 and method 100 of the present disclosure offer several advantages. Using the system 10 and method 100, wireless communication reliability is improved by mitigating bandwidth saturation. Error correction is adjusted to provide optimal redundancy for important data without overutilizing available bandwidth. Furthermore, bitrates are optimized to provide optimal quality of service to wireless clients. Additionally, keyframe transmission times are adjusted based on predicted future bandwidth to ensure successful keyframe transmission and minimize disruption.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for increasing network reliability for a wireless client, the method comprising:
determining a predicted bandwidth of the wireless client at a next time step;
determining a network status, wherein the network status includes one of: a normal network status and a disruption event status;
determining an error correction block size based at least in part on the network status and the predicted bandwidth of the wireless client;
adjusting one or more server transmission characteristics of a server packet stream based at least in part on the error correction block size, wherein the server packet stream includes a plurality of data packets; and
transmitting the server packet stream to the wireless client based at least in part on the one or more server transmission characteristics.

2. The method of claim 1, wherein determining the error correction block size further comprises:
determining a bandwidth budget based at least in part on the predicted bandwidth of the wireless client with a formula:
$${B}_{b} = {B}_{p} - {B}_{a}$$
wherein B_{b} is the bandwidth budget, Bₚ is the predicted bandwidth of the wireless client at the next time step, and Bₐ is a utilized bitrate of the wireless client at a current time step;
determining a packet corruption probability; and
determining the error correction block size based at least in part on the bandwidth budget and the packet corruption probability using a formula:
$${N}_{e} = max ( min ( {N}_{w} , ⌈ \frac{1}{{P}_{c}} ⌉ ) , ⌊ \frac{{B}_{a}}{{B}_{b}} ⌋ )$$
wherein Nₑ is the error correction block size, N_{w} is a predetermined maximum number of packets to wait before decoding into video frames, P_{c} is the packet corruption probability, Bₐ is the utilized bitrate of the wireless client at the current time step, and Bₚ is the predicted bandwidth of the wireless client at the next time step.

3. The method of claim 2, wherein determining the packet corruption probability further comprises:
determining the packet corruption probability using an inhomogeneous Poisson Point Process equation evaluated with a moving time window.

4. The method of claim 3, wherein determining the packet corruption probability further comprises:
resetting the moving time window to begin at a current time in response to determining that the network status is the disruption event status.

5. The method of claim 1, wherein adjusting the one or more server transmission characteristics further comprises:
generating one or more error correction packets for inclusion in the server packet stream based at least in part on the error correction block size;
determining an optimized server bitrate for the next time step based at least in part on the error correction block size; and
determining an optimized keyframe transmission timing based at least in part on the error correction block size.

6. The method of claim 5, wherein generating the one or more error correction packets further comprises:
grouping one or more of the plurality of data packets into a plurality of error correction blocks, wherein a quantity of data packets in each of the plurality of error correction blocks is the error correction block size; and
generating the one or more error correction packets, wherein each of the one or more error correction packets encodes one of the plurality of error correction blocks.

7. The method of claim 6, wherein grouping the one or more of the plurality of data packets into the plurality of error correction blocks further comprises:
determining a packet importance of each of the plurality of data packets in response to determining that the network status is the disruption event status; and
grouping the one or more of the plurality of data packets into the plurality of error correction blocks based at least in part on the packet importance of each of the plurality of data packets in response to determining that the network status is the disruption event status.

8. The method of claim 7, wherein grouping the one or more of the plurality of data packets into the plurality of error correction blocks further comprises:
comparing the packet importance of each of the plurality of data packets to a predetermined importance threshold; and
grouping the one or more of the plurality of data packets into the plurality of error correction blocks based at least in part on the packet importance of each of the plurality of data packets, wherein each of the plurality of error correction blocks includes one or more of the plurality of data packets having a packet importance greater than or equal to the predetermined importance threshold.

9. The method of claim 5, wherein determining the optimized server bitrate further comprises:
determining the optimized server bitrate for the next time step using an optimization algorithm, wherein a sum of the optimized server bitrate and an error correction bitrate does not exceed the predicted bandwidth of the wireless client, wherein the error correction bitrate is determined based at least in part on the error correction block size, and wherein a decrease between the optimized server bitrate for a current time step and the optimized server bitrate for the next time step is minimized.

10. The method of claim 5, wherein determining the optimized keyframe transmission timing further comprises:
determining a total keyframe data size to transmit a keyframe and associated keyframe error correction packets based at least in part on the error correction block size;
determining an estimated keyframe transmission duration based at least in part on the total keyframe data size and the predicted bandwidth for the next time step; and
adjusting a keyframe transmission start time in response to determining that the estimated keyframe transmission duration is greater than a predetermined maximum waiting time.

11. A system for increasing network reliability for a vehicle, the system comprising:
a server communication system in wireless communication with one or more wireless clients, wherein the one or more wireless clients includes the vehicle; and
a server controller in electrical communication with the server communication system, wherein the server controller is programmed to:
determine a predicted bandwidth of the vehicle at a next time step;
determine a network status of the vehicle, wherein the network status includes one of: a normal network status and a disruption event status;
determine an error correction block size based at least in part on the network status and the predicted bandwidth of the vehicle;
generate one or more error correction packets for a server packet stream based at least in part on the error correction block size, wherein the server packet stream includes a plurality of data packets; and
transmit the server packet stream and the one or more error correction packets to the vehicle using the server communication system.

12. The system of claim 11, wherein to determine the network status of the vehicle, the server controller is further programmed to:
determine the network status to be the disruption event status in response to determining that the vehicle has switched wireless base stations at a current time step or that the vehicle is predicted to switch wireless base stations at the next time step.

13. The system of claim 12, wherein to determine the error correction block size, the server controller is further programmed to:
determine a bandwidth budget based at least in part on the predicted bandwidth of the vehicle with a formula:
$${B}_{b} = {B}_{p} - {B}_{a}$$
wherein B_{b} is the bandwidth budget, Bₚ is the predicted bandwidth of the vehicle at the next time step, and Bₐ is a utilized bitrate of the vehicle at the current time step;
determine a packet corruption probability using an inhomogeneous Poisson Point Process equation evaluated with a moving time window; and
determine the error correction block size based at least in part on the bandwidth budget and the packet corruption probability using a formula:
$${N}_{e} = max ( min ( {N}_{w} , ⌈ \frac{1}{{P}_{c}} ⌉ ) , ⌊ \frac{{B}_{a}}{{B}_{b}} ⌋ )$$
wherein Nₑ is the error correction block size, N_{w} is a predetermined maximum number of packets to wait before decoding into video frames, P_{c} is the packet corruption probability, Bₐ is the utilized bitrate of the vehicle at the current time step, and Bₚ is the predicted bandwidth of the vehicle at the next time step.

14. The system of claim 13, wherein to determine the packet corruption probability, the server controller is further programmed to:
reset the moving time window to begin at a current time in response to determining that the network status is the disruption event status.

15. The system of claim 14, wherein to generate the one or more error correction packets, the server controller is further programmed to:
group one or more of the plurality of data packets into a plurality of error correction blocks, wherein a quantity of data packets in each of the plurality of error correction blocks is the error correction block size; and
generate the one or more error correction packets, wherein each of the one or more error correction packets encodes one of the plurality of error correction blocks.

16. The system of claim 15, wherein to group the one or more of the plurality of data packets into the plurality of error correction blocks, the server controller is further programmed to:
determine a packet importance of each of the plurality of data packets in response to determining that the network status is the disruption event status; and
group the one or more of the plurality of data packets into the plurality of error correction blocks based at least in part on the packet importance of each of the plurality of data packets in response to determining that the network status is the disruption event status.

17. The system of claim 16, wherein to group the one or more of the plurality of data packets into the plurality of error correction blocks, the server controller is further programmed to:
compare the packet importance of each of the plurality of data packets to a predetermined importance threshold; and
group the one or more of the plurality of data packets into the plurality of error correction blocks based at least in part on the packet importance of each of the plurality of data packets, wherein each of the plurality of error correction blocks includes one or more of the plurality of data packets having a packet importance greater than or equal to the predetermined importance threshold.

18. A method for increasing network reliability for a vehicle, the method comprising:
determining a predicted bandwidth of the vehicle at a next time step;
determining a network status, wherein the network status includes one of: a normal network status and a disruption event status, wherein the disruption event status indicates that the vehicle has switched wireless base stations at a current time step or that the vehicle is predicted to switch wireless base stations at the next time step;
determining an error correction block size based at least in part on the network status and the predicted bandwidth of the vehicle;
generating one or more error correction packets for inclusion in a server packet stream based at least in part on the error correction block size, wherein the server packet stream includes a plurality of data packets; and
transmitting the server packet stream including the one or more error correction packets to the vehicle.

19. The method of claim 18, wherein determining the error correction block size further comprises:
determining a bandwidth budget based at least in part on the predicted bandwidth of the vehicle with a formula:
$${B}_{b} = {B}_{p} - {B}_{a}$$
wherein B_{b} is the bandwidth budget, Bₚ is the predicted bandwidth of the vehicle at the next time step, and Bₐ is a utilized bitrate of the vehicle at the current time step;
determining a packet corruption probability using an inhomogeneous Poisson Point Process equation evaluated with a moving time window;
resetting the moving time window to begin at a current time in response to determining that the network status is the disruption event status; and
determining the error correction block size based at least in part on the bandwidth budget and the packet corruption probability using a formula:
$${N}_{e} = max ( min ( {N}_{w} , ⌈ \frac{1}{{P}_{c}} ⌉ ) , ⌊ \frac{{B}_{a}}{{B}_{b}} ⌋ )$$
wherein Nₑ is the error correction block size, N_{w} is a predetermined maximum number of packets to wait before decoding into video frames, P_{c} is the packet corruption probability, Bₐ is the utilized bitrate of the vehicle at the current time step, and Bₚ is the predicted bandwidth of the vehicle at the next time step.

20. The method of claim 19, wherein generating the one or more error correction packets further comprises:
determining a packet importance of each of the plurality of data packets in response to determining that the network status is the disruption event status;
comparing the packet importance of each of the plurality of data packets to a predetermined importance threshold; and
grouping the one or more of the plurality of data packets into a plurality of error correction blocks based at least in part on the packet importance of each of the plurality of data packets, wherein a quantity of data packets in each of the plurality of error correction blocks is the error correction block size, and wherein each of the plurality of error correction blocks includes one or more of the plurality of data packets having a packet importance greater than or equal to the predetermined importance threshold.
